(19) United States
(12) Patent Application Publication
(10) Pub. No.: US 2013/0095761 A1
(43) Pub. Date: Apr. 18, 2013

(54) SYSTEMS AND METHODS FOR SEAMLESS SWITCHING BETWEEN A PLURALITY OF WIRELESS CONNECTIONS FOR WIRELESS TRANSMISSIONS

(71) Applicants: Enlai CHU, Beijing (CN); Renbang JIANG, Beijing (CN)

(72) Inventors: Enlai CHU, Beijing (CN); Renbang JIANG, Beijing (CN)

(73) Assignee: MEDIATEK SINGAPORE PTE. LTD., Singapore (SG)

(21) Appl. No.: 13/458,549

(22) Filed: Apr. 27, 2012

(30) Foreign Application Priority Data
Oct. 14, 2011 (CN) 201110312146.6

(51) Int. Cl. H04W 84/02; H04W 4/00

(52) U.S. Cl. 455/41.2

(57) ABSTRACT

A wireless communications system is provided with a first wireless communications module, a second wireless communications module, and a connection management module. The first wireless communications module operates in compliance with a first wireless communication protocol, and transmits data by wireless transceiving via a first wireless connection. The second wireless communications module operates in compliance with a second wireless communication protocol. The connection management module requests the second wireless communications module to establish a second wireless connection in response to a signal indicator of the first wireless connection having a value within a predetermined range, and transfers the data to the second wireless communications module to be transmitted via the second wireless connection.

### CROSS REFERENCE TO RELATED APPLICATIONS

This application claims priority of China Patent Application No. 201110312146.6, filed on Oct. 14, 2011, and the entirety of which is incorporated by reference herein.

### BACKGROUND OF THE INVENTION

1. Field of the Invention

The invention relates generally to wireless communications technologies, and more particularly, to systems and methods for seamless switching between a plurality of wireless connections for wireless transmissions.

2. Description of the Related Art

In a typical wireless communications environment, a wireless communications device, such as a mobile phone (also known as cellular or cell phone), a laptop computer with wireless communications capability, a Personal Digital Assistant (PDA), or others, may provide wireless access services to users using various wireless communications technologies, such as the Bluetooth (BT) technology, Wireless Fidelity (WiFi) technology, WiFi Direct technology, WLAN Authentication and Privacy Infrastructure (WAPI) technology, the Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, and others.

To an increasing extent, a multitude of communication functions are being merged into one single wireless communications device. As shown in FIG. 1, a mobile phone may connect to a Wireless Local Area Network (WLAN) via a WiFi module thereof and simultaneously communicate with a BT handset (or a BT car audio, or others) through a BT module thereof. A WLAN system is typically implemented inside of buildings as an extension of wired Local Area Networks (LANs) and is able to provide the last few meters of connectivity between a wired network and mobile or fixed devices. Referring to FIG. 1, a WLAN is established by an Access Point (AP) connecting to a LAN by an Ethernet cable. The AP typically receives, buffers, and transmits data between the WLAN and the wired network infrastructure. The AP may support, on average, twenty devices and have a coverage varying from 20 meters in an area with obstacles (walls, stairways, elevators etc) to 100 meters in an area with clear line of sight. BT is an open wireless protocol for exchanging data over short distances from fixed and mobile devices, creating Personal Area Networks (PANs). The mobile phone may receive the Voice over Internet Protocol (VoIP) data via the WiFi module and further transmit the VoIP data through an established PAN to the BT handset, and vice versa. Alternatively, the mobile phone may transmit digital music through the established PAN to be played back in the BT handset. Generally, in the described architecture, the multiple wireless communications modules thereof are configured to operate independently. However, under some circumstances, communication failure may occur when the signal quality of the connection provided by any one of the WiFi module and the BT module is bad or the connection is lost abnormally. Thus, it is desirable to effectively coordinate the operations of the multiple wireless communications modules, so that the data originally to be transmitted by the wireless communications module with communication failure may instead be transmitted by the wireless communications module with fair signal quality, thereby improving the transmission efficiency of the wireless communications device.

### BRIEF SUMMARY OF THE INVENTION

In light of the previously described problems, the present invention provides systems and methods for seamless switching between a plurality of wireless connections for wireless transmissions.

One aspect of the present invention discloses a wireless communications system, comprising a first wireless communications module, a second wireless communications module, and a connection management module. The first wireless communications module is configured to operate in compliance with a first wireless communication protocol, and transmit data by wireless transceiving via a first wireless connection. The second wireless communications module is configured to operate in compliance with a second wireless communication protocol. The connection management module is configured to request the second wireless communications module to establish a second wireless connection in response to a signal indicator of the first wireless connection having a value within a predetermined range, and transfer the data to the second wireless communications module to be transmitted via the second wireless connection.

Another aspect of the present invention discloses a method for seamless switching between a plurality of wireless connections for wireless transmissions. The method comprises the steps of providing a first wireless communications module and a second wireless communications module operating in compliance with a first wireless communication protocol and a second wireless communication protocol, respectively, wherein the first wireless communications module transmits data by wireless transceiving via a first wireless connection, requesting the second wireless communications module to establish a second wireless connection in response to a signal indicator of the first wireless connection having a value within a predetermined range, and transferring the data to the second wireless communications module to be transmitted via the second wireless connection.

Yet another aspect of the present invention discloses a wireless communications system, comprising a first wireless communications module, a second wireless communications module, and a connection management module. The first wireless communications module is configured to operate in compliance with a first wireless communication protocol, and transmit data by wireless transceiving via a first wireless connection. The second wireless communications module is configured to operate in compliance with a second wireless communication protocol. The connection management module is configured to temporarily store the data which was originally to be transmitted by the first wireless communications module, request the second wireless communications module to establish a second wireless connection, transfer the temporarily stored data to the second wireless communications module to be transmitted via the second wireless connection, and request the first wireless communications module to cancel the first wireless connection.

Other aspects and features of the present invention will become apparent to those with ordinarily skill in the art upon review of the following descriptions of specific embodiments of systems and methods for seamless switching between a plurality of wireless connections for wireless transmissions. Particularly, in the systems and methods for seamless switching between a plurality of wireless connections for wireless transmissions provided by the present invention, the data originally to be transmitted by the wireless communications module with communication failure may instead be transmitted by the wireless communications module with fair signal quality, so that the transmission efficiency may be improved.

### BRIEF DESCRIPTION OF THE DRAWINGS

The invention can be more fully understood by reading the subsequent detailed description and examples with references made to the accompanying drawings, wherein:

FIG. 1 shows a cellular phone connecting to a Wireless Local Area Network (WLAN) via a WLAN module thereof as well as communicating with a Bluetooth handset through a Bluetooth module thereof;

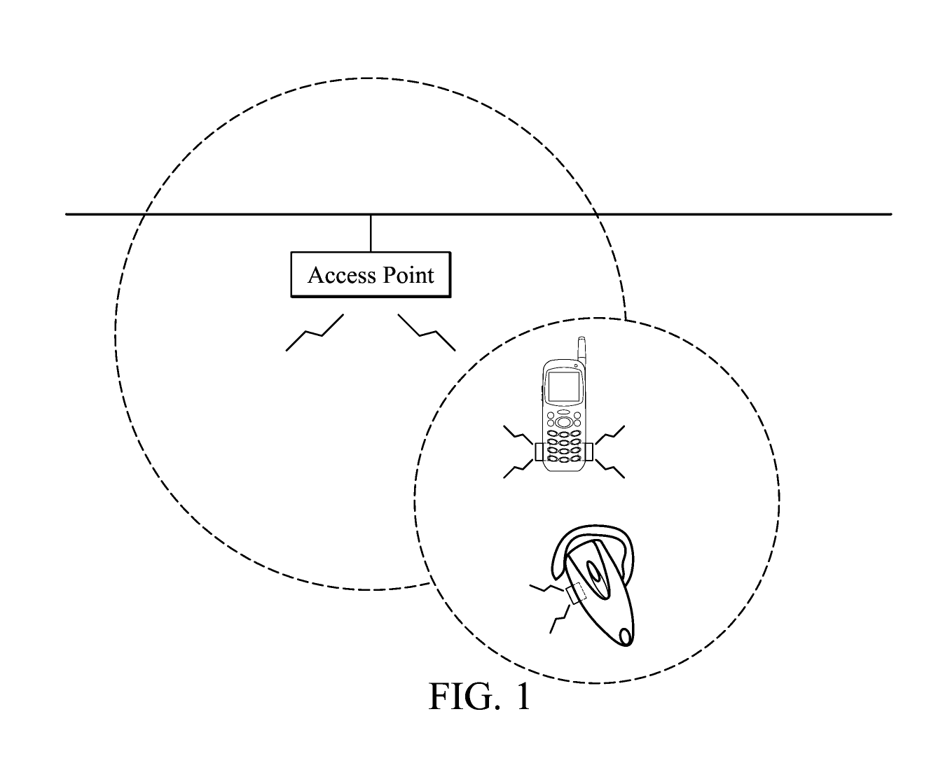

FIG. 2 is a schematic diagram illustrating a wireless communications system according to an embodiment of the invention;

FIG. 3 is a flow chart illustrating the method for seamless switching between a plurality of wireless connections for wireless transmissions according to an embodiment of the invention; and

FIG. 4 is a flow chart illustrating the method for seamless switching between a plurality of wireless connections for wireless transmissions according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

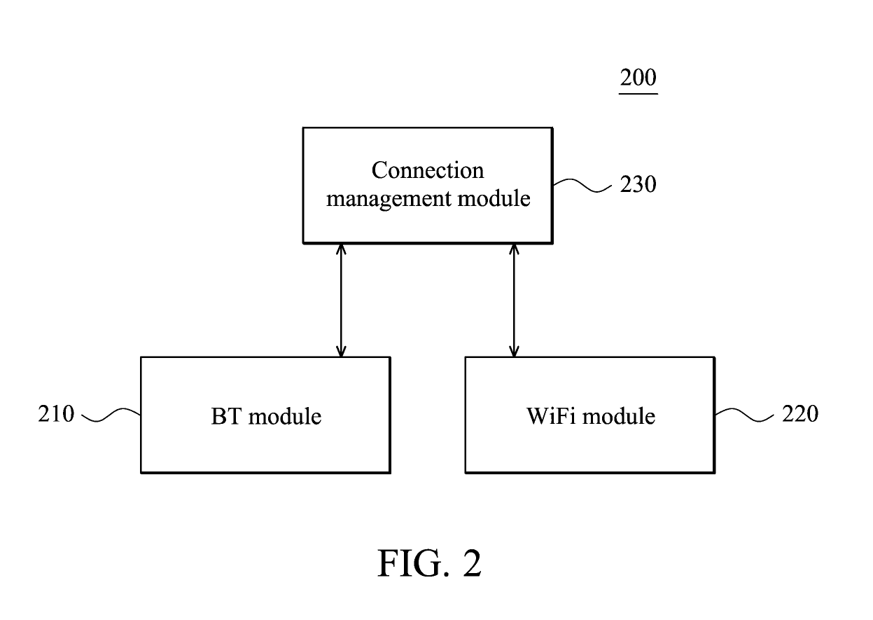

FIG. 2 is a schematic diagram illustrating a wireless communications system according to an embodiment of the invention. The wireless communications system 200 comprises a first wireless communications module, such as the BT module 210, and a second wireless communications module, such as the WiFi module 220. The BT module 210 provides the function of wireless communications in compliance with the communication protocol of the BT technology, while the WiFi module 220 provides the function of wireless communications in compliance with the communication protocol of the WiFi technology. Each of the BT module 210 and the WiFi module 220 may comprise a Radio Frequency (RF) unit (not shown) and a Baseband unit (not shown). The Baseband unit may contain multiple hardware devices to perform baseband signal processing, including analog to digital conversion (ADC)/digital to analog conversion (DAC), gain adjusting, modulation/demodulation, encoding/decoding, and so on. The RF unit may receive RF wireless signals, convert the received RF wireless signals to baseband signals, which are processed by the Baseband unit, or receive baseband signals from the Baseband unit and convert the received baseband signals to RF wireless signals, which are later transmitted. The RF unit may also contain multiple hardware devices to perform radio frequency conversion. For example, the RF unit may comprise a mixer to multiply the baseband signals with a carrier oscillated in the radio frequency of the mobile communication system, wherein the radio frequency may be 2.4 GHz utilized in BT or WiFi technology, or others depending on the Radio Access Technology (RAT) in use.

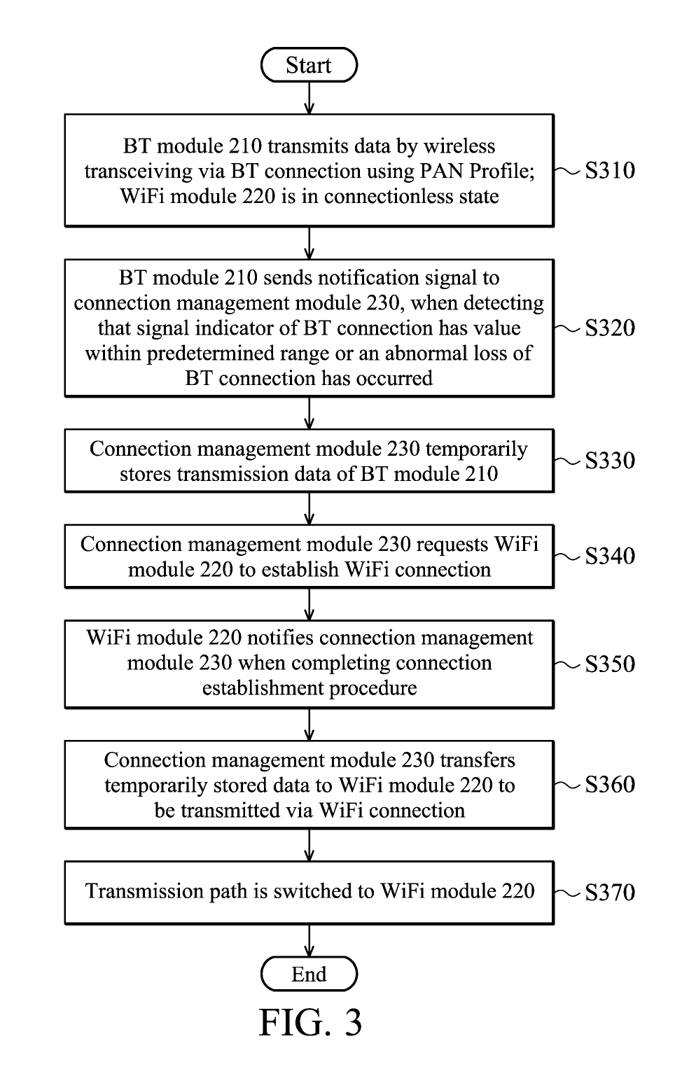

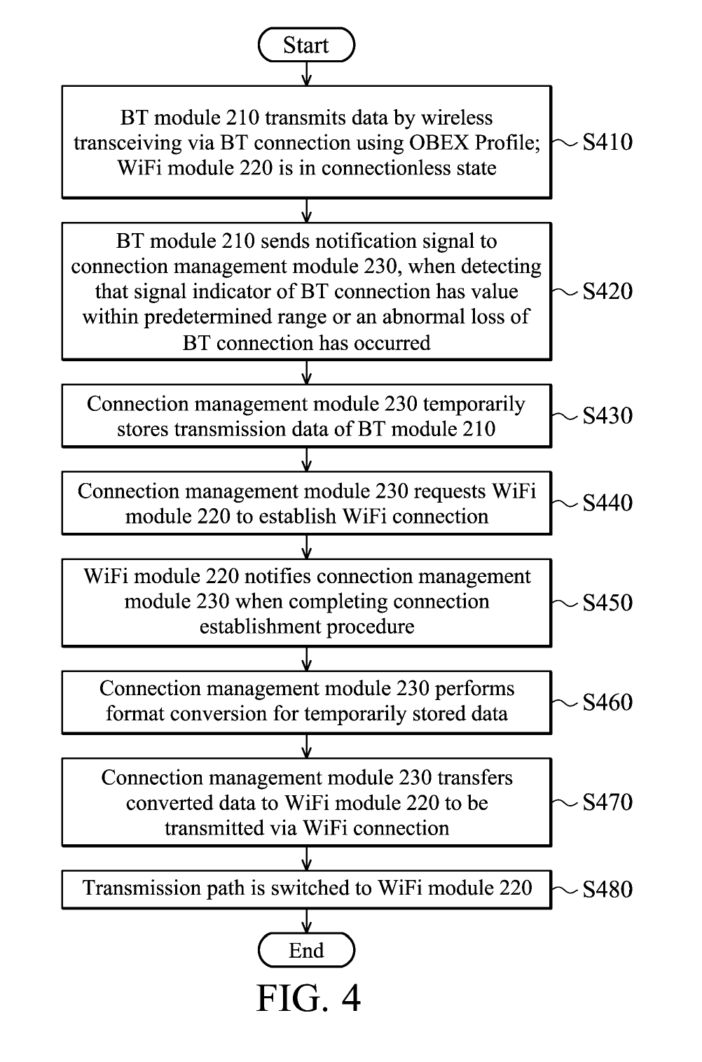

In addition, the wireless communications system 200 comprises the connection management module 230 which is configured to coordinate the operations of the BT module 210 and the WiFi module 220 as described in detail later in FIGS. 3 and 4. FIG. 3 is a flow chart illustrating the method for seamless switching between a plurality of wireless connections for wireless transmissions according to an embodiment of the invention. To begin, in this embodiment, the BT module 210 is configured to transmit data by wireless transceiving via a BT connection using the PAN Profile, and the WiFi module 220 is configured to be in a connectionless state (step S310). Later, when detecting that the signal indicator of the BT connection has a value within a predetermined range (e.g., the signal quality or the transmission rate of the BT connection is higher/lower than a predetermined threshold), or detecting that an abnormal loss of the BT connection has occurred, the BT module 210 sends a notification signal to the connection management module 230 (step S320). The notification signal may contain the type of a trigger event. For example, if the notification signal is transmitted in response to detecting that the signal quality of the BT connection is bad or fair, the trigger event may present a signal quality indicator; or if the notification signal is transmitted in response to detecting that the transmission rate of the BT connection is low or good, the trigger event may present a transmission rate indicator; or if the notification signal is transmitted in response to detecting that an abnormal loss of the BT connection has occurred, the trigger event may be a connection-loss event. In one embodiment, the BT module 210 may determine the signal quality of the BT connection according to the Received Signal Strength Indicator (RSSI) of the BT connection, and the predetermined threshold may be set by the user or may be generated by the BT module 210 according to history transmission status or used profile type. For example, the predetermined threshold may be set to a relatively low value when the used profile type is not sensitive to transmission delays, and may be set to a relatively high value when the used profile type is sensitive to transmission delays. In one embodiment, if the loss of the BT connection occurs due to causes other than a user request (e.g., out-of-sync with the software or hardware of the BT module 210, or the hardware of the BT module 210 is an external device and is removed unexpectedly, etc.), then it may be considered as an abnormal loss of the BT connection and the connection management module 230 may further set a flag to indicate whether to proceed with the following steps. That is, if the notification signal indicates that the loss of the BT connection has occurred due to user request, the connection management module 230 sets the flag to “OFF” to end the procedure. Otherwise, if the notification signal indicates to trigger the seamless switching between wireless connections, or indicates that the signal indicator of the BT connection has a value within the predetermined range, or indicates an abnormal loss of the BT connection, then the connection management module 230 sets the flag to “ON” to continue the procedure. Please note that, the seamless switching requested by the user is not the same as the previously described user requested loss of the BT connection. Specifically, the user requested loss of the BT connection refers to a loss of the wireless connection by user request, while the seamless switching requested by the user refers to a switch of the transmission mode in which at least one wireless connection exists.

Subsequent to the step S320, the BT module 210 starts passing the transmission data to the connection management module 230 to be stored temporarily (step S330). Based on the notification signal, the connection management module 230 decides to perform seamless switching for the BT connection. To do so, the connection management module 230 first sends a control signal to request the WiFi module 220 to establish a WiFi connection (step S340). When receiving the control signal, the WiFi module 220 starts to perform the connection establishment procedure, and then returns a notification signal to the connection management module 230 when completing the connection establishment procedure (step S350). The notification signal may contain the type of a trigger event, wherein the trigger event may be a connection-setup event. Next, the connection management module 230 decides whether to convert the format of the specified communication scheme of the PAN Profile utilized by the BT module 210 originally for the temporarily stored data, when receiving the notification signal. Specifically, the connection management module 230 first needs to decide whether the specified communication scheme of the PAN Profile is the same as the communication scheme associated with the WiFi connection. In this embodiment, since the PAN Profile which is originally used by the BT module 210 for transmitting the temporarily stored data and the WiFi connection both specify the TCP/IP (Transmission Control Protocol/Internet Protocol) communication scheme, no format conversion is necessary. Subsequently, the connection management module 230 transfers the temporarily stored data to the WiFi module 220 to be transmitted via the WiFi connection (step S360). After the temporarily stored data has been transmitted, the connection management module 230 switches the transmission path from the BT module 210 to the WiFi module 220 (step S370). If reduction of power consumption is further required, the BT connection may be canceled and the task of data transmission may be completely submitted under the control of the connection management module 230 and the WiFi module 220.

FIG. 4 is a flow chart illustrating the method for seamless switching between a plurality of wireless connections for wireless transmissions according to another embodiment of the invention. To begin, in this embodiment, the BT module 210 is configured to transmit data by wireless transceiving via a BT connection using the Object Exchange (OBEX) Profile, and the WiFi module 220 is configured to be in a connectionless state (step S410). Later, when detecting that the signal indicator of the BT connection has a value within a predetermined range (e.g., the signal quality or the transmission rate of the BT connection is higher/lower than a predetermined threshold), or detecting that an abnormal loss of the BT connection has occurred, the BT module 210 sends a notification signal to the connection management module 230 (step S420). The notification signal may contain the type of a trigger event. For example, if the notification signal is transmitted in response to detecting that the signal quality of the BT connection is bad or fair, the trigger event may present a signal quality indicator; or if the notification signal is transmitted in response to detecting that the transmission rate of the BT connection is low or good, the trigger event may present a transmission rate indicator; or if the notification signal is transmitted in response to detecting that an abnormal loss of the BT connection has occurred, the trigger event may be a connection-loss event. In one embodiment, the BT module 210 may determine the signal quality of the BT connection according to the RSSI of the BT connection, and the predetermined threshold may be set by the user or may be generated by the BT module 210 according to history transmission status or used profile type. For example, the predetermined threshold may be set to a relatively low value when the used profile type is not sensitive to transmission delays, and may be set to a relatively high value when the used profile type is sensitive to transmission delays. In one embodiment, if the loss of the BT connection occurs due to causes other than user request (e.g., out-of-sync with the software or hardware of the BT module 210, or the hardware of the BT module 210 is an external device and is removed unexpectedly, etc.), then it may be considered as an abnormal loss of the BT connection and the connection management module 230 may further set a flag to indicate whether to proceed with the following steps. That is, if the notification signal indicates that the loss of the BT connection has occurred due to user request, the connection management module 230 sets the flag to “OFF” to end the procedure. Otherwise, if the notification signal indicates to trigger the seamless switching between wireless connections, or indicates that the signal indicator of the BT connection has a value within the predetermined range, or indicates an abnormal loss of the BT connection, then the connection management module 230 sets the flag to “ON” to continue the procedure.

Subsequent to the step S420, the BT module 210 starts passing the transmission data to the connection management module 230 to be stored temporarily (step S430). Based on the notification signal, the connection management module 230 decides to perform seamless switching for the BT connection. To do so, the connection management module 230 first sends a control signal to request the WiFi module 220 to establish a WiFi connection (step S440). When receiving the control signal, the WiFi module 220 starts to perform the connection establishment procedure, and then returns a notification signal to the connection management module 230 when completing the connection establishment procedure (step S450). The notification signal may contain the type of a trigger event, wherein the trigger event may be a connection-setup event. Next, the connection management module 230 decides whether to convert the format of the specified communication scheme of the OBEX Profile utilized by the BT module 210 originally for the temporarily stored data, when receiving the notification signal. Specifically, the connection management module 230 first needs to decide whether the specified communication scheme of the OBEX Profile is the same as the communication scheme associated with the WiFi connection. In this embodiment, since the OBEX Profile which was originally used by the BT module 210 for transmitting the temporarily stored data specifies the FTP (File Transfer Profile) communication scheme and the WiFi connection specifies the TCP/IP communication scheme, the connection management module 230 performs a format conversion for the temporarily stored data (step S460). Please note that the detailed descriptions regarding the format conversion are omitted herein since they are beyond the scope of the invention, and references may be made to the specifications of the FTP and TCP/IP communication schemes. Subsequently, the connection management module 230 transfers the converted data to the WiFi module 220 to be transmitted via the WiFi connection (step S470). After the converted data has been transmitted, the connection management module 230 switches the transmission path from the BT module 210 to the WiFi module 220 (step S480). If reduction of power consumption is further required, the BT connection may be canceled and the task of data transmission may be completely submitted under the control of the connection management module 230 and the WiFi module 220.

Note that, in other embodiments, if the used profile of the BT module 210 is the Advanced Audio Distribution Profile (A2DP) or Hands Free Profile (HFP), or other profiles not specifying TCP/IP, the format conversion is required to be performed by the connection management module 230 before transferring the temporarily stored data to the WiFi module 220.

The method for seamless switching between a plurality of wireless connections for wireless transmissions may be initiated by a user request or particular application. That is, the sending of the notification signal in the steps S320 and S420 may be triggered by the BT module 210 receiving a command from the user or application, which indicates the seamless switching between wireless connections is to be performed. The notification signal may contain the type of a trigger event, wherein the trigger event may be a connection-loss event. Alternatively, the trigger event may be a proactive connection-loss event which indicates that the loss of wireless connection has been requested by the user, and when the BT connection is lost abnormally, the trigger event may be a non-proactive connection-loss event, so that the connection management module 230 may be able to distinguish between the different types of connection loss.

Advantageously, the method for seamless switching between a plurality of wireless connections for wireless transmissions may improve the operation flexibility of the wireless communications system. In one embodiment, the connection management module 230 may transfer the data which was originally to be transmitted by a wireless communications module with communication failure or bad signal quality to another wireless communications module with fair signal quality to be transmitted, thereby improving transmission efficiency and ensuring the completeness of the transmission data. In another embodiment, the connection management module 230 may transfer the data which was originally to be transmitted by a wireless communications module with fair signal quality to another wireless communications module with less power consumption to be transmitted, thereby saving power and extending the operating time of the wireless communications system.

Note that, the BT module 210 and the WiFi module 220 are only given as examples for carrying out the invention. The invention may also be applied with different wireless communications technologies which are in compliance with different wireless communication protocols. Alternatively, the invention may also be applied for seamless switching from the WiFi module 220 to the BT module 210.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A wireless communications system, comprising:
a first wireless communications module configured to operate in compliance with a first wireless communication protocol, and transmit data by wireless transceiving via a first wireless connection;
a second wireless communications module configured to operate in compliance with a second wireless communication protocol; and
a connection management module configured to request the second wireless communications module to establish a second wireless connection in response to a signal indicator of the first wireless connection having a value within a predetermined range, and transfer the data to the second wireless communications module to be transmitted via the second wireless connection.

2. The wireless communications system of claim 1, wherein, prior to the step of transferring the data, the connection management module is further configured to convert a first communications scheme utilized by the first wireless communications module for the data transmission via the first wireless connection into a second communications scheme associated with the second wireless connection.

3. The wireless communications system of claim 1, wherein the first wireless communications module is further configured to detect whether a signal quality or transmission rate of the first wireless connection is lower or higher than a threshold, and if so, send a notification signal to the connection management module to trigger the step of requesting the second wireless communications module to establish the second wireless connection and the step of transferring the data.

4. The wireless communications system of claim 3, wherein, in response to receiving the notification signal, the connection management module is further configured to temporarily store the data which was originally to be transmitted by the first wireless communications module, and when the second wireless connection is established, transfer the data to the second wireless communications module to be transmitted via the second wireless connection.

5. The wireless communications system of claim 3, wherein the signal quality of the first wireless connection is determined according to a Received Signal Strength Indicator (RSSI) of the first wireless connection.

6. The wireless communications system of claim 1, wherein the step of requesting the second wireless communications module to establish the second wireless connection and the step of transferring the data are performed by the connection management module in response to an abnormal loss of the first wireless connection.

7. The wireless communications system of claim 6, wherein the first wireless communications module is further configured to detect whether the abnormal loss of the first wireless connection has occurred, and if so, send a notification signal to the connection management module to trigger the step of requesting the second wireless communications module to establish the second wireless connection and the step of transferring the data.

8. The wireless communications system of claim 7, wherein, in response to receiving the notification signal, the connection management module is further configured to temporarily store the data which was originally to be transmitted by the first wireless communications module, and when the second wireless connection is established, transfer the data to the second wireless communications module to be transmitted via the second wireless connection.

9. The wireless communications system of claim 1, wherein the step of requesting the second wireless communications module to establish the second wireless connection and the step of transferring the data are performed in response to a user request.

10. The wireless communications system of claim 9, wherein, in response to receiving the user request, the connection management module is further configured to temporarily store the data which was originally to be transmitted by the first wireless communications module, and when the second wireless connection is established, transfer the data to the second wireless communications module to be transmitted via the second wireless connection.

11. A method for seamless switching between a plurality of wireless connections for wireless transmissions, comprising:
providing a first wireless communications module and a second wireless communications module operating in compliance with a first wireless communication protocol and a second wireless communication protocol, respectively, wherein the first wireless communications module transmits data by wireless transceiving via a first wireless connection;
requesting the second wireless communications module to establish a second wireless connection in response to a signal indicator of the first wireless connection having a value within a predetermined range; and
transferring the data to the second wireless communications module to be transmitted via the second wireless connection.

12. The method of claim 11, further comprising, in response to a signal quality or transmission rate of the first wireless connection being lower or higher than a threshold, performing the following steps:
temporarily storing the data which was originally to be transmitted by the first wireless communications module; and
when the second wireless connection is established, transferring the data to the second wireless communications module to be transmitted via the second wireless connection.

13. The method of claim 12, wherein the signal quality of the first wireless connection is determined according to a Received Signal Strength Indicator (RSSI) of the first wireless connection.

14. The method of claim 11, wherein the step of requesting the second wireless communications module to establish the second wireless connection and the step of transferring the data are performed in response to an abnormal loss of the first wireless connection.

15. The method of claim 14, further comprising, in response to the abnormal loss of the first wireless connection, performing the following steps:
temporarily storing the data which was originally to be transmitted by the first wireless communications module; and
when the second wireless connection is established, transferring the data to the second wireless communications module to be transmitted via the second wireless connection.

16. The method of claim 11, wherein the step of requesting the second wireless communications module to establish the second wireless connection and the step of transferring the data are performed in response to a user request.

17. The method of claim 16, further comprising, in response to the user request, performing the following steps:
temporarily storing the data which was originally to be transmitted by the first wireless communications module; and
when the second wireless connection is established, transferring the data to the second wireless communications module to be transmitted via the second wireless connection.

18. A wireless communications system, comprising:
a first wireless communications module configured to operate in compliance with a first wireless communication protocol, and transmit data by wireless transceiving via a first wireless connection;
a second wireless communications module configured to operate in compliance with a second wireless communication protocol; and
a connection management module configured to temporarily store the data which was originally to be transmitted by the first wireless communications module, request the second wireless communications module to establish a second wireless connection, transfer the temporarily stored data to the second wireless communications module to be transmitted via the second wireless connection, and request the first wireless communications module to cancel the first wireless connection.

19. The wireless communications system of claim 18, wherein, prior to the step of transferring the temporarily stored data, the connection management module is further configured to convert a first communications scheme utilized by the first wireless communications module originally for transmitting the temporarily stored data via the first wireless connection into a second communications scheme associated with the second wireless connection.

20. The wireless communications system of claim 18, wherein the step of temporarily storing the data and the step of transferring the temporarily stored data are performed in response to a user request, or in response to a signal quality or transmission rate of the first wireless connection being lower or higher than a threshold.
